(19) United States
(12) Patent Application Publication
(10) Pub. No.: US 2009/0088056 A1
(43) Pub. Date: Apr. 2, 2009

(54) GRINDING WHEEL

(75) Inventors: Hiroshi TAKEHARA, Kasugai-shi (JP); Tomohiro Inagaki, Anjo-shi (JP); Takayuki Moroto, Okazaki-shi (JP); Hiroshi Imaike, Okazaki-shi (JP); Shinji Soma, Handa-shi (JP); Koji Morita, Anjo-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: TOYODA VAN MOPPES LTD., Okazaki-shi (JP); JTEKT Corporation, Osaka-shi (JP)

(21) Appl. No.: 12/172,466

(22) Filed: Jul. 14, 2008

(30) Foreign Application Priority Data
Sep. 28, 2007 (JP) 2007-255651

(51) Int. Cl. B24D 5/00; C09K 3/14; B24D 5/14

(52) U.S. Cl. 451/544; 51/307

(57) ABSTRACT

In a grinding wheel comprising a disc-like core member and a ring-shape grinding wheel layer wherein superabrasive grains selected from cubic boron nitride particles and diamond particles are contained together with aggregates in a bonding material, the aggregates are made of porous ceramics particles and have an average particle size which is in a range of 70% to 150% relative to the average particle size of the superabrasive grains, and bridges made of the bonding material are formed between the aggregates adjoining to one another or between the aggregates and the superabrasive grains adjoining to the aggregates.

### INCORPORATION BY REFERENCE

This application is based on and claims priority under 35 U.S.C. 119 with respect to Japanese patent application No. 2007-255651 filed on Sep. 28, 2007, the entire content of which is incorporated herein by reference.

### BACKGROUND OF THE INVENTION

1. Field of the Invention

The present invention relates to a grinding wheel employing porous ceramics particles as aggregates.

2. Discussion of the Related Art

In grinding wheels employing vitrified bond for example, it has been known to add aggregates consisting of alumina abrasive grains or silicon carbide abrasive grains to the bonding material in order to enhance the strength by preventing cracks which would otherwise be caused due to excessive contraction after a burning process, and in order to lower the grinding resistance by lengthening the grain-to-grain interval (i.e., by lowering the concentration of abrasive grains). The vitrified bond is melted in the burning process to form bond bridges between abrasive grains. However, when a cooling process then proceeds, there is generated a shearing stress due to the difference in thermal expansion between superabrasive grains (CBN abrasive grains) and the aggregates consisting of alumina abrasive grains, and the shearing stress tends to break or cut the bond bridges. It results as a consequence that the bond bridges once formed are cut. To overcome the drawback, in a grinding wheel 100 shown in FIG. 4 and described in Japanese examined published patent No. 1-38628, an improvement is made to prevent the bond bridges 106 from being cut due to thermal stress. This can be done by blending in bonding material 102 aggregates 104 consisting of oxide particles which have a thermal expansion coefficient equal to or less than ±2.0×10⁻⁶K⁻¹ relative to the thermal expansion coefficient in a range of the room temperature to 500° C. of the superabrasive grains 108. The superabrasive grains and the aggregates are blended at a volume ratio in the range of 90:10 to 10:90.

Further, in the invention described in Japanese examined published patent No. 7-16879, as shown in FIG. 5, there has been proposed a grinding wheel 110 wherein porous particles 114 relatively smaller in grain size than abrasive grains 112 are contained as aggregates in bonding material. With this configuration, during a truing operation or a grinding operation, the porous particles 114 are crushed to recede from the abrasive grains forming cutting edges, so that the grinding wheel 110 can be lowered in grinding resistance.

However, in the technology described in the first mentioned Japanese patent, during a grinding operation, the aggregates 104 are not crushed upon contact with a ground material (workpiece) and remain to contact the ground material at the same position or height as the superabrasive grains 108, as shown in FIG. 6. This brings about a situation that the aggregates 104 go to be cut bit by bit through abrasion. This causes the grinding resistance to increase and a substantial heat to be generated during the grinding operation. Because the aggregates are low in thermal conductivity, the heat remains in the ground material, whereby a problem arises in that the ground material not only has grinding burns formed thereon, but also is deteriorated in strength.

Further, the technology described in the last mentioned Japanese patent is effective in lowering the grinding resistance. However, in this technology, the bonding material 116 is lowered in strength as a result that numerous small-diameter aggregates 114 having cavities (pores) are contained in each bond bridge 113 which holds adjoining abrasive grains 112. This causes the bond bridges 113 to be fractured by the grinding load, so that the abrasive grains 112 are liable to easily fall off to shorten the service life of the grinding wheel.

### SUMMARY OF THE INVENTION

It is therefore a primary object of the present invention to provide an improved grinding wheel capable of decreasing the grinding resistance during a grinding operation without lowering the bonding strength of the bonding material so that the grinding performance and the wheel life can be enhanced.

Briefly, according to the present invention, there is provided an improved grinding wheel comprising a grinding wheel layer in which superabrasive grains selected from cubic boron nitride particles and diamond particles are contained together with aggregates in a bonding material. The aggregates are made of porous ceramics particles and have an average particle size which is in a range of 70% to 150% relative to the average particle size of the superabrasive grains, and bridges made of the bonding material are formed between the aggregates adjoining to one another or between the aggregates and the superabrasive grains adjoining to the aggregates.

With this construction, the average particle size of the aggregates contained in the bonding material is in a range of 70% to 150% relative to the average particle size of the superabrasive grains, and the aggregates are similar in particle size to the superabrasive grains. Because the particle size of the aggregates are relatively large, the aggregates which are inside the grinding wheel layer not to contact a workpiece being ground can stand in all against a large grinding load. Further, unlike the second prior art, it does not occur that many number of small, porous aggregates come to be contained in the bond bridges formed between adjoining superabrasive grains and hence, cause the bond bridges to be fragile and fractured. The relatively large aggregates become nucleuses to effectively form the bond bridges between mutually adjoining aggregates and between aggregates and superabrasive grains adjoining thereto, so that the grinding wheel can be strengthened in structure. This advantageously results in preventing the superabrasive grains from falling off easily, so that the service life of the grinding wheel can be lengthened.

In addition, during each of a truing operation and a grinding process, those aggregates which reside at the same position (i.e., the front line) as those abrasive grains facing a truing tool or a workpiece are crushed upon contact with the truing tool or the workpiece due to fragility attributed to the porousness and are retracted from the cutting edges of those abrasive grains at the front line. Thus, it can be realized easily to form the grinding surface of the grinding wheel which is low in grinding resistance, through the truing operation, and it is also possible to prevent the occurrence of grinding burns which are caused by friction contacts between the workpiece and the aggregates. Further, the crushed porous aggregates at the front line not only form chip pockets which serve to receive and discharge cutting chips, but also facilitate coolant to reach a grinding point as well as to spread in the grinding wheel layer, so that the grinding efficiency can also be enhanced.

### BRIEF DESCRIPTION OF THE DRAWINGS

The foregoing and other objects and many of the attendant advantages of the present invention may readily be appreciated as the same becomes better understood by reference to the preferred embodiment of the present invention when considered in connection with the accompanying drawings, wherein like reference numerals designate the same or corresponding parts throughout several views, and in which:

FIG. 1 is a general side view of a grinding wheel in an embodiment according to the present invention;

FIG. 2 is an enlarged fragmentary sectional view showing the structure of a grinding wheel layer of the grinding wheel;

FIG. 3 is an enlarged fragmentary sectional view showing the structure of the grinding wheel layer at a grinding surface of the grinding wheel during a grinding operation;

FIG. 4 is an enlarged fragmentary sectional view showing the structure of a grinding wheel layer of a grinding wheel in a first prior art;

FIG. 5 is an enlarged fragmentary sectional view showing the structure of a grinding wheel layer of a grinding wheel in a second prior art; and

FIG. 6 is an enlarged fragmentary sectional view showing the structure of the grinding wheel layer at a grinding surface of the grinding wheel in the first prior art during a grinding operation.

### DETAILED DESCRIPTION OF THE PREFERRED EMBODIMENT

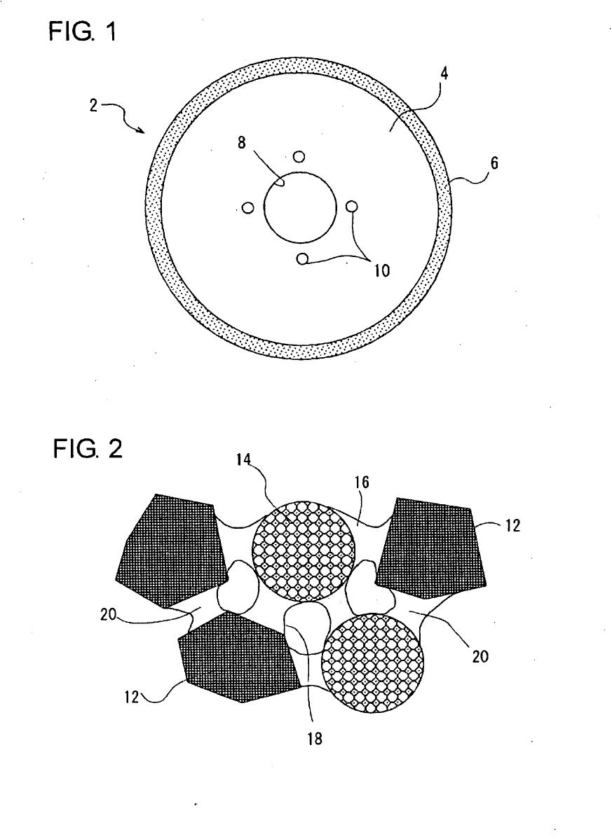

Hereafter, a grinding wheel in an embodiment according to the present invention will be described with reference to the accompanying drawings. FIG. 1 is a general side view of the grinding wheel, and FIG. 2 is an enlarged fragmentary sectional view showing the structure of the grinding wheel at a portion (i.e., the front row or line) adjacent to a grinding surface.

Referring now to FIG. 1, the grinding wheel 2 is composed of a disc-like core member 4 and an annular or ring-shape grinding wheel layer 6 which is secured to the circumferential surface of the core member 4 with a suitable adhesive or by sintering. The core member 4 is made of a metal material such as steel, aluminum, titanium or the like, a FRP (fiber-reinforced plastic) material, a ceramics material (e.g., a conventional grinding wheel). The grinding wheel layer 6 is formed by fixing a grinding wheel layer ring formed to a ring-shape on the circumferential surface of the core member 4 or by arranging a plurality of segmented grinding chips on the circumferential surface of the core member 4 in a circular array. At the center of the core member 4, a center hole 8 is formed to pass through the core member 4 and is adapted to fit on a centering boss which protrudes from a spindle end of a wheel spindle (not shown) rotatably carried on a wheel head referred to later. The core member 4 has a plurality of bolt-through holes 10 formed around the center hole 8 (preferably, equiangular intervals on a bolt circle), and the bolt-through holes 10 allow fastening bolts (not shown) to pass therethrough and to be screwed into screw holes opening on the spindle end of the wheel spindle. The grinding wheel 2 can be secured to the wheel spindle by inserting the fastening bolts into the bolt-through holes 10 and by screwing the fastening bolts into the screwed holes.

In a grinding machine with the wheel head on which the grinding wheel 2 is mounted, the wheel head and a work table (both not shown) are slidably guided in respective directions orthogonal to each other (e.g., X and Z-axis directions). The wheel spindle driven by an electric motor (not shown) is carried to be rotatable about an axis which extends in parallel with the axis of a workpiece (a cylindrical part) W ground with the grinding wheel 2. The work table mounts a work head and a foot stock (both not shown) thereon, which rotatably support the workpiece W about the axis parallel to the moving direction of the work table.

Referring to FIG. 2, the structure of the grinding wheel layer 6 is shown in an exaggerated scale, in which superabrasive grains 12 consisting of, e.g., CBN (cubic boron nitride) and aluminum oxide particles 14 as aggregates consisting of porous ceramics particles are bonded with vitrified bond. The vitrified bond 16 forms bridges 20 between adjoining superabrasive grains 12, adjoining aluminum oxide particles 14 and between each superabrasive grain and one or more aluminum oxide particles 14 adjoining thereto thereby to bond them and forms a plurality of pores 18 between the bridges 20. As the aluminum oxide particles 14, there can be used those having the porosity in a range of 10% to 80%. Preferably, by choosing the porosity in a range of 30% to 60%, the aluminum oxide particles 14 can be effectively crushed during a grinding operation and can retain the strength required for the structure of the grinding wheel layer 6. The average grain size of the CBN superabrasive grains 12 is, for example, 115 micrometers (#170), while the average grain size of the aluminum oxide particles 14 is, for example, 100 micrometers (#200). In this case, the average grain size of the aluminum oxide particles 14 is about 87% of the average grain size of the superabrasive grains 12. By setting the grain size of the aggregates relative to the grain size of the superabrasive grains 12 to the range of 70% to 150% in this way, it has been experimentally grasped that the aluminum oxide particles 14 as aggregates can maintain the strength required for the structure of the grinding wheel layer 6. It is presumable that a primary reason for being capable of maintaining such strength is that the porous aggregates (aluminum oxide particles 14) do not cause the bridges made of the bonding material (vitrified bond 16) to be frangible. In a modified form, diamond abrasive grains may be used in substitution for CBN abrasive grains.

Next, description will be made regarding a method for manufacturing the grinding wheel 2 in the present embodiment. First of all, the grinding wheel layer 6 is manufactured using CBN abrasive grains. In this case, CBN superabrasive grains 12, aluminum oxide particles (aggregates) 14 and vitrified bond 16 are mixed at a predetermined mixing ratio. For example, the quantity of the aluminum oxide particles 14 used there is less than 50 volume percents of the entire grinding wheel layer 6. Further, in advance of the mixing, the aforementioned mixing ratio is determined taking the followings into consideration. That is, where the vitrified bond 16 is too much in volume percent relative to the CBN superabrasive grains 12 and the aluminum oxide particles 14, bridges of the bonding material (i.e., bridging portions 20) become hard to be formed between adjoining aluminum oxide particles 14 as well as between the aluminum oxide particles 14 and superabrasive grains 12 adjacent thereto. On the contrary, where the aluminum oxide particles 14 are too little in volume percent relative to the CBN superabrasive grains 12, the concentration of the superabrasive grains 12 is increased to result in a greater grinding resistance during a grinding operation.

The mixture is filled in a mold which defines therein a space corresponding to the ring-shape grinding wheel layer 6, and is press-formed. Then, the press-formed ring-shape grinding wheel layer 6 is pulled out from the mold and is then burned at around 1,000° C. which is the burning temperature for vitrified bond 16, whereby the ring-shape grinding wheel layer 6 is manufactured. Subsequently, the burned grinding wheel layer 6 is fixed at its internal surface to the circumferential surface of the core member 4 with an adhesive to constitute the grinding wheel 2. The vitrified bond 6 is melted during the burning process to form bridging portions (bridges) 20 and pores 18 between adjoining superabrasive grains 12. At this time, unlike the second prior art, it does not occur that many small, porous filler materials (corresponding to aggregates) are contained in the vitrified bond 16 forming the bridging portions 20 between the adjoining superabrasive grains 12, because the diameter or size of the aluminum oxide particles 14 as aggregates is similar to that of the superabrasive grains 12. The aluminum oxide particles 14 become nucleuses of a mesh formed by the vitrified bond 16 and effectively serve to form the bridging portions 20 between adjoining aluminum oxide particles 14 or between superabrasive grains 12 and aluminum oxide particles 14 adjoining thereto. Therefore, as a result of suppressing the falling-off of the superabrasive grains 12, it can be realized not only to strengthen the structure of the grinding wheel 2, but also to lengthen the service life of the grinding wheel 2. Further, by increasing the content of the superabrasive grains 12 in the grinding wheel layer 6 and hence, by increasing the number of the bridging portions 20 formed between adjoining superabrasive grains 12, the existence rate in the grinding wheel layer 6 of the porous aluminum oxide particles 14 having the fragile nature is decreased thereby to increase the strength of the grinding wheel 2.

Next, description will be made regarding the operation in a grinding process using the grinding wheel 2 as constructed above. First of all, the grinding wheel 2 is secured to the wheel spindle of the aforementioned wheel head, and the wheel spindle is driven by the electric motor to rotate the grinding wheel 2. Further, a workpiece W rotatably supported between the work head and the foot stock (both not shown) is rotated about its own axis by driving another motor connected to the work spindle of the work head. Then, a grinding operation is carried out by advancing the wheel head toward the workpiece W in a direction which is, for example, perpendicular to the axis of the workpiece W.

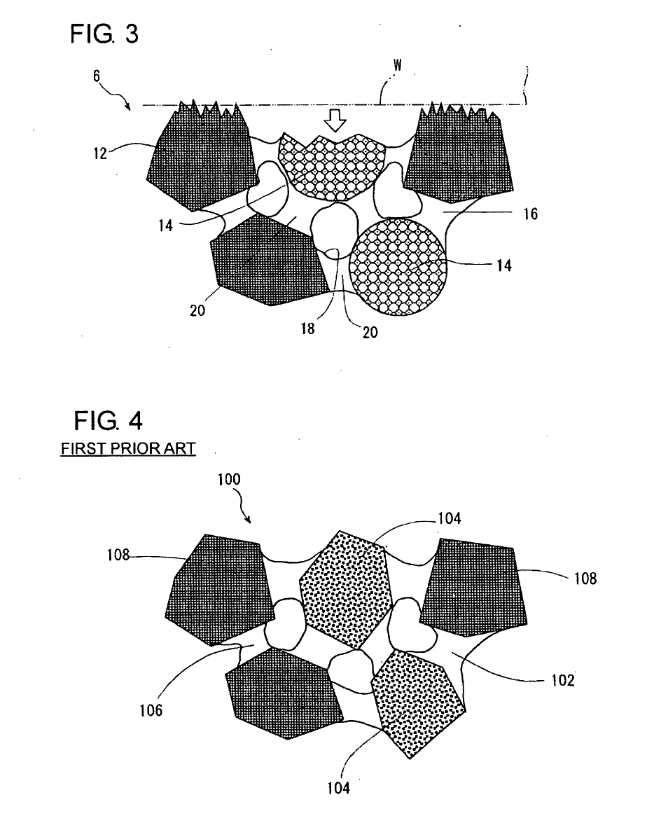

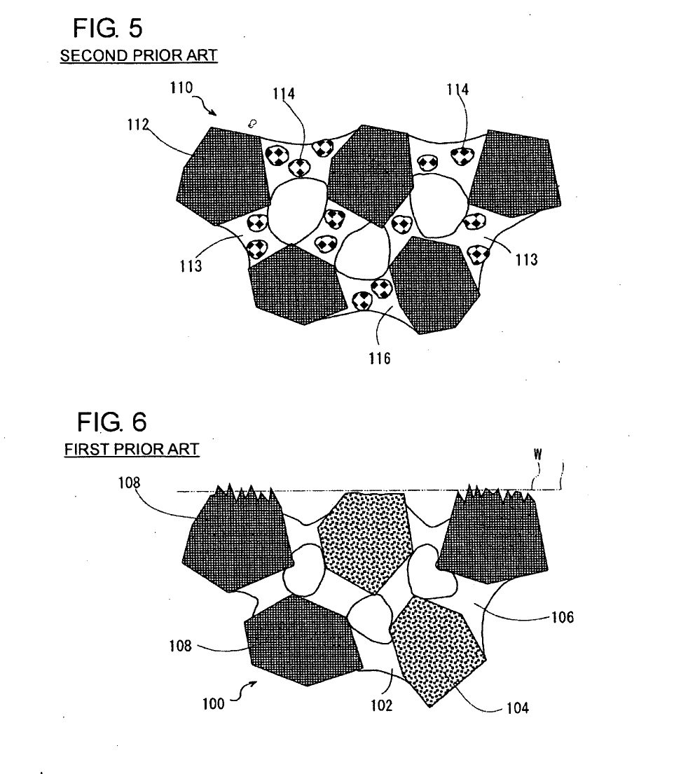

Before the beginning of the grinding operation, the aluminum oxide particles 14 and the superabrasive grains 12 at the front line to define the circumferential surface (i.e., grinding surface) of the grinding wheel 2 have their front or forward cutting edges at approximately the same height as illustrated in FIG. 2. Because the aluminum oxide particles 14 are porous and fragile, the front cutting edges of the aluminum oxide particles 14 are crushed upon contact with the surface of the workpiece W during the grinding process and are retracted from the front edges of the superabrasive grains 12 at the front line which edges act as cutting edges facing the workpiece W, as shown in FIG. 3.

Because the front edges of the aluminum oxide particles 14 are retracted, the grinding resistance can be lowered, and the occurrence of grinding burns can be suppressed or prevented though such grinding burns would otherwise be caused if the aluminum oxide particles 14 continued to contact the workpiece W. Further, by being crushed, the porous aluminum oxide particles 14 at the front line not only form chip pockets which serve to receive and discharge cutting chips, but also facilitate coolant to reach a grinding point, at which the grinding wheel 2 contacts the workpiece W, as well as to spread in the grinding wheel layer 6, so that the grinding efficiency can be enhanced. In addition, during a truing operation after repetition of the aforementioned grinding operation, it becomes easy for a truing tool to precisely true the grinding surface of the grinding wheel 2, because the grinding resistance on the grinding surface has already been lowered by the retraction of the front edges of the aluminum oxide particles 14 at the front line in the preceding grinding operation.

The present embodiment uses aluminum oxide particles as porous ceramics particles constituting aggregates. However, the present invention is not limited to the use of aluminum oxide particles. For example, it is possible to selectively use various porous materials known in the art, such as mullite particles, composite oxide particles made from aluminum oxide and chromium oxide, and the like.

The present embodiment uses vitrified bond as bonding material. However, the present invention is not limited to the use vitrified bond. For example, it is possible to use a resinoid bond in an epoxy resin group capable of forming the bond bridges.

Obviously, further modifications and variations of the present invention are possible in light of the above teachings. It is therefore to be understood that within the scope of the appended claims, the present invention may be practiced otherwise than as specifically described herein.

What is claimed is:

1. A grinding wheel comprising a grinding wheel layer in which superabrasive grains selected from cubic boron nitride particles and diamond particles are contained together with aggregates in a bonding material, wherein:
the aggregates are made of porous ceramics particles and have an average particle size which is in a range of 70% to 150% relative to the average particle size of the superabrasive grains, and
bridges made of the bonding material are formed between the aggregates adjoining to one another or between the aggregates and the superabrasive grains adjoining to the aggregates.

2. The grinding wheel as set forth in claim 1, wherein the bridges made of the bonding material are formed also between the superabrasive grains adjoining to one another.

3. The grinding wheel as set forth in claim 1, wherein the aggregates made of the porous ceramics particles are easier to be crushed than the superabrasive grains upon contact with a workpiece being ground with the grinding wheel so that the aggregates at the circumferential surface of the grinding wheel are retracted from the superabrasive grains at the circumferential surface to form chip pockets.

4. The grinding wheel as set forth in claim 1, wherein the grinding wheel layer takes a ring shape, further comprising:
a core member formed to take a disc-like shape and fixedly fitted in an internal surface of the ring-shape grinding wheel layer at a circumferential surface thereof.
